(19) United States
(12) Patent Application Publication
(10) Pub. No.: US 2005/0263710 A1
(43) Pub. Date: Dec. 1, 2005

(54) DETECTOR AND METHOD THEROF FOR DETECTING INTENSITY OF ULTRAVIOLET RAYS WITHIN DIFFERENT WAVE BANDS

(76) Inventors: Shang-Chih Tsou, Chang-Hua City (TW); Chih-Chin Chang, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 10/904,655

(22) Filed: Nov. 22, 2004

(30) Foreign Application Priority Data
Jun. 1, 2004 (TW) 093115673

(51) Int. Cl. G01J 1/42

(52) U.S. Cl. 250/372

(57) ABSTRACT

A detector and method for detecting intensity of ultraviolet (UV) rays are disclosed. The detector has a plurality of UV photo-diodes for detecting intensities of UV rays within different wave bands, an A/D converter for converting analog output signals of the UV photo-diodes into corresponding digital signals, and a micro-controller for controlling operations of the detector. Each of the wave bands overlaps at least one of the other wave bands. The micro-controller calculates the intensity of each overlapped wave band according to the digital signals.

### BACKGROUND OF INVENTION

1. Field of the Invention

The invention relates to a detection method of an ultraviolet detector, and more particularly, to a method for detecting the intensity of ultraviolet rays in a plurality of wave bands.

2. Description of the Prior Art

Please refer to FIG. 1. FIG. 1 is a functional diagram showing a prior art ultraviolet detector. As shown in FIG. 1, an ultraviolet ray detector 10 includes a plurality of filters 12-18, a plurality of photodiodes 22, a plurality of amplifiers 24, an A/D converter 26 (Analog to Digital Converter, ADC), a processing circuit 28, a display 30, a replacement button 32, and a vibrator 34. In order to filter out lights within a particular wave band, only lights with certain wavelengths are allowed to pass through each of the filters 12-18. For example, only ultraviolet rays in a wave band of UVA are allowed to pass through the filter 14, only ultraviolet rays in a wave band of UVB are allowed to pass through the filter 16, and only ultraviolet rays in a wave band of UVC are allowed to pass through the filter 18. Essentially, the property of each of the photodiodes 22 is identical and by receiving irradiation from the ultraviolet rays, the photodiodes 22 will produce a corresponding voltage signal or current signal. However, due to the effect of the filters 12-18, each of the photodiodes 22 is only irradiated by lights in a particular wave band. After the irradiation, the signals generated by the photodiodes 22 are transferred to a corresponding amplifier 24 to be magnified. Next, the magnified signals are converted by the A/D converter 26 to a digital signal form that can be processed by the processing circuit 28. According to the time signal generated by the vibrator 34, the processing circuit 28 can process the output digital signals generated by the A/D converter 26. Upon receiving the output digital signals, the processing circuit 28 is also able to calculate the intensity of the ultraviolet rays in each wave band UVA, UVB, and UVC and present the result on the display 30. In addition, when the replacement button 32 is activated by a user, the detector 10 will be reset to its original state.

Nevertheless, a much higher cost is generally required for fabricating the prior art detector 10 as many more photodiodes 22 and corresponding filters 12-18 are needed. In addition, the prior art also employs a much more complex structure and assembly as each of the photodiodes 22 is required to operate in coordination with the corresponding filter 12-18 for detecting the ultraviolet rays in a specific wave band.

### SUMMARY OF INVENTION

It is therefore an objective of the present invention to provide an ultraviolet detector with simpler structure for solving the problems caused by the prior art ultraviolet detectors.

According to the present invention, a method for detecting intensity of ultraviolet rays in a plurality of wave bands comprises the following: utilizing an ultraviolet photo-diode for detecting the ultraviolet rays within a predetermined time; collecting an input signal from the ultraviolet photo-diode after the ultraviolet photo-diode is irradiated by the ultraviolet rays within the predetermined time for calculating a total intensity of the ultraviolet rays; and multiplying the total intensity of the ultraviolet rays by a corresponding ratio of each wave band for calculating the intensity of ultraviolet rays in each wave band.

The present invention also includes a detector for detecting the intensity of ultraviolet rays, which comprises the following: a plurality of ultraviolet photo-diodes for detecting a plurality of ultraviolet wave bands and generating corresponding analog signals, in which each of the detected wave bands overlaps with at least one of the other detected wave bands; an analog/digital converter electrically connected to the ultraviolet photo-diode for converting analog output signals of the ultraviolet photo-diodes into corresponding digital signals; and a micro-controller electrically connected to the analog/digital converter for controlling the detector and calculating the intensity of ultraviolet rays in each overlapping wave band according to the digital signals converted by the analog/digital converter.

Finally, the present invention includes a method for detecting intensity of ultraviolet rays in a plurality of wave bands, in which the method comprises the following: utilizing a plurality of ultraviolet photo-diodes for detecting a plurality of ultraviolet wave bands within a predetermined time, in which each of the detected wave bands overlaps with at least one of the other detected wave bands; collecting input signals from the ultraviolet photo-diodes after the ultraviolet photo-diodes are irradiated by the ultraviolet rays within the predetermined time for calculating a total intensity of the ultraviolet rays in each detected wave band; and calculating the ultraviolet intensity in each overlapping wave band of the detected wave bands according to the total intensity of the ultraviolet rays of the detected wave bands and the overlapping condition of each wave band.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a functional diagram showing the prior art ultraviolet detector.

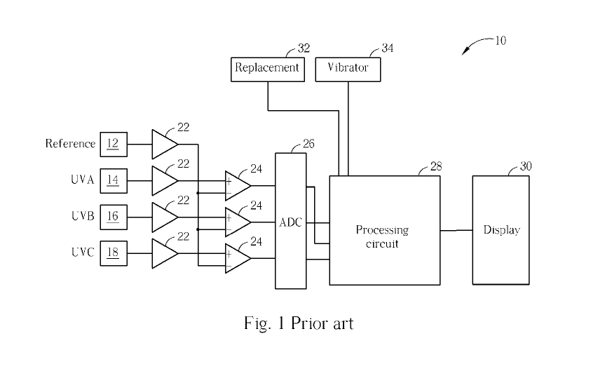

FIG. 2 is a functional diagram showing the detector of the first embodiment of the present invention.

FIG. 3 is a relational diagram showing the ultraviolet intensity received by the ultraviolet photo-diodes and its output voltage according to FIG. 2.

FIG. 4 is a functional diagram showing the detector of the second embodiment of the present invention.

FIG. 5 is a relational diagram showing the relationship between the ultraviolet intensity received by the ultraviolet photo-diode and its output current according to FIG. 4.

FIG. 6 is a flow chart diagram showing the detection process according to FIG. 2 and FIG. 4.

FIG. 7 is a functional diagram showing the detector of the third embodiment of the present invention.

FIG. 8 is a functional diagram showing the detector of the fourth embodiment of the present invention.

### DETAILED DESCRIPTION

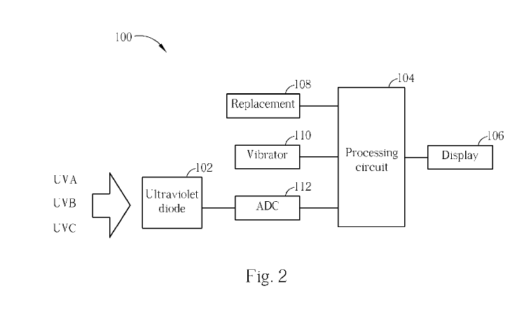

Please refer to FIG. 2. FIG. 2 is a functional diagram showing the detector 100 of the first embodiment of the present invention. The detector 100 includes an ultraviolet photo-diode 102, an analog/digital converter 112, a micro-controller 104, a display 106, a replacement button 108, and a vibrator 110. The devices are electrically connected and the electrical voltage or current signals are also transmitted among the devices. In contrast to the prior art detector 10, the detector 100 includes no additional filters and the wave bands detected by the ultraviolet photo-diode 102 are divided into three groups, including UVA, UVB, and UVC. Due to the irradiation of ultraviolet rays, the ultraviolet photo-diode 102 will generate a number of corresponding analog voltage signals. The analog signals are converted by the A/D converter 112 to a digital signal form that can be processed by the micro-controller 104. After the digital signals converted by the A/D converter 112 are received, the micro-controller 104 will process the signals according to the time signal generated by the vibrator 110 and calculate the intensity of the ultraviolet rays in the wave bands UVA, UVB, and UVC according the digital signals received. After calculation, the result is shown on the display 106. In addition, when the replacement button 108 is activated by a user, the detector 10 will be reset to its original state.

After the detector 100 is activated, the ultraviolet photo-diode 102 will detect the ultraviolet rays within a predetermined time. In order to obtain the total intensity of the ultraviolet rays within the predetermined time, the signals output from the ultraviolet photo-diode 102 are first converted by the A/D converter 112 and then collected by the micro-controller 104. Next, the total intensity of the ultraviolet rays obtained is multiplied separately by a corresponding fixed ratio of each of the wave bands UVA, UVB, and UVC via the micro-controller 104 in order to calculate the intensity of the ultraviolet rays in each wave band UVA, UVB, and UVC. The fixed ratio is essentially estimated and stored in the micro-controller 104. For example, if the fixed ratio between the ultraviolet rays and each wave band UVA, UVB, and UVC is 0.2:0.5:0.3 and the total intensity of the ultraviolet rays obtained is 100 mW/cm², then the intensity of the ultraviolet rays in each wave band UVA, UVB, and UVC will be 20 mW/cm², 50 mW/cm², and 30 mW/cm².

It should also be noted that the micro-controller 104 is suitable for detecting a stable light source such as daylight as the ultraviolet intensity is calculated by the micro-controller 104 in different wave bands according to a fixed ratio. Hence, due to its relatively simple circuit layout, the detector 100 can be installed into numerous devices such as cellular phones or watches for detecting the ultraviolet intensity of daylight at any time of the day.

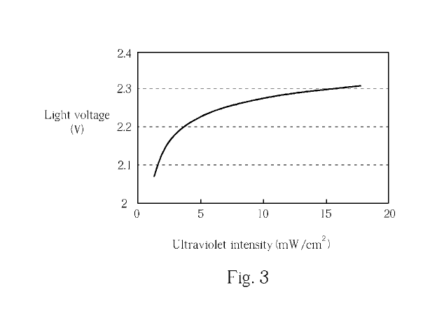

Please refer to FIG. 3. FIG. 3 is a relational diagram showing the ultraviolet intensity received by the ultraviolet photo-diodes and its output light voltage according to FIG. 2. As shown in FIG. 3, the relationship between the amount of ultraviolet intensity received by the ultraviolet photo-diode 102 and its output light voltage is a one to one relationship. By utilizing this relationship, the micro-controller 104 is able to calculate the ultraviolet intensity received by the ultraviolet photo-diode 102.

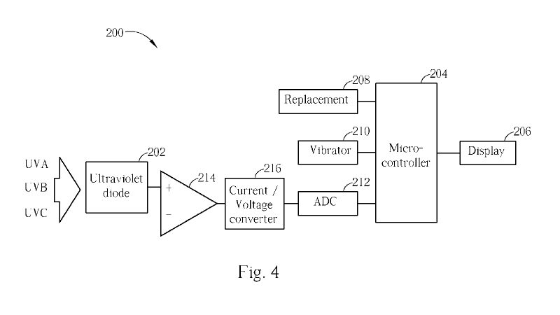

Please refer to FIG. 4. FIG. 4 is a functional diagram showing the detector of the second embodiment of the present invention. Similar to the detector 100, detector 200 also includes an ultraviolet photo-diode 202, an analog/digital converter 212, a display 206, a replacement button 208, and a vibrator 210 and these devices essentially perform similar functions as the ultraviolet photo-diode 102, A/D converter 112, display 106, replacement button 108 and the vibrator 110. As stated previously, the detector 100 detects the intensity of the ultraviolet rays according to the light voltage generated after the ultraviolet photo-diode 102 is irradiated by the ultraviolet rays. In contrast to the detector 100, detector 200 detects the intensity of ultraviolet rays according to the light current generated when the ultraviolet photo-diode 102 is irradiated by the ultraviolet rays. The detector 200 also includes an amplifier 214 for magnifying and transmitting the electric signals output from the ultraviolet photo-diode to a current/voltage converter 216. After the current signals are converted to voltage signals, the A/D converter 214 will convert the magnified electric current signals to corresponding digital signals and pass the converted signals to the micro-controller 204.

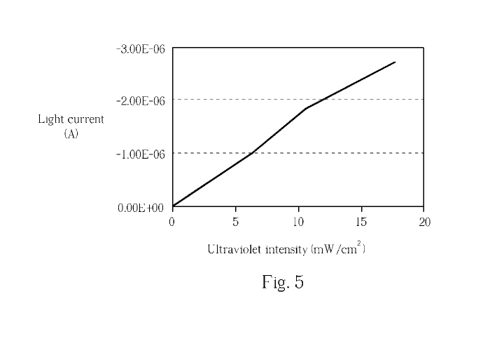

Please refer to FIG. 5. FIG. 5 is a relational diagram showing the relationship between the ultraviolet intensity received by the ultraviolet photo-diode and its output light current. As shown in FIG. 5, the relationship between the amount of ultraviolet intensity received by the ultraviolet photo-diode 202 and its output light current is a one to one relationship. By utilizing this relationship and multiplying the total ultraviolet intensity by a fixed ratio, the micro-controller 204 is able to calculate the ultraviolet intensity received by the ultraviolet photo-diode 102 in each wave band UVA, UVB, and UVC. Similar to detector 100, the detector 200 is also suitable for detecting a stable ultraviolet ray source such as daylight.

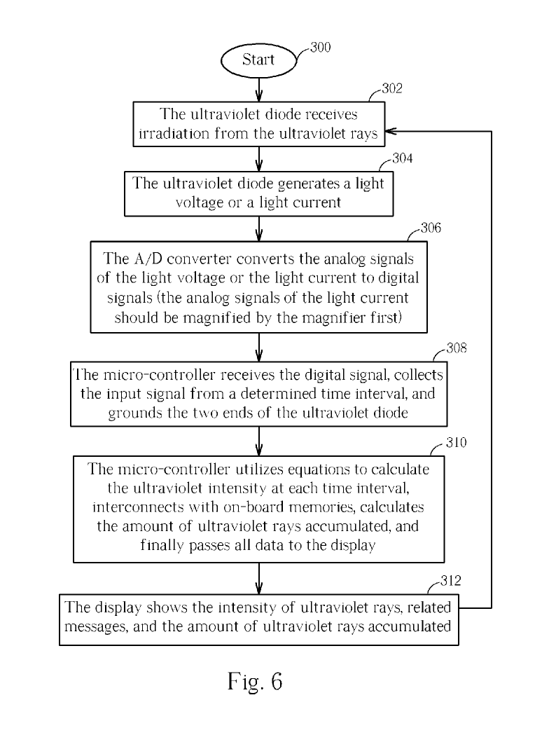

Please refer to FIG. 6. FIG. 6 is a flow chart diagram showing the detection process according to FIG. 2 and FIG. 4. The detection process includes the following steps:

Step 300: turn on the power to activate the detector 100 or 200;

Step 302: the ultraviolet photo-diode 102 or 202 receives irradiation from the ultraviolet rays;

Step 304: the ultraviolet photo-diode 102 or 202 generates a light voltage or current;

Step 306: the A/D converter 112 or 212 converts the analog signals of light voltage or light current to digital signals and the output analog signals output by the ultraviolet photo-diode 202 of the detector 200 are magnified by the amplifier 214;

Step 308: the micro-controller 104 or 204 receives the digital signal, collects the input signal from a determined time interval and grounds the two ends of the ultraviolet photo-diode 102 and 202 at the end of each time interval for balancing the internal electric charge of the ultraviolet photo-diode 102 or 202. By doing so, the detected result is not likely to be affected by the previous result when the detector 100 or 200 is reactivated;

Step 310: the micro-controller 104 or 204 utilizes equations to calculate the ultraviolet intensity at each time interval (according to the fixed ratio stated above), interconnects with on-board memories, calculates the amount of ultraviolet rays accumulated, and finally passes all data to the display 106 or 206; and

Step 312: after the display 106 or 206 shows the intensity of ultraviolet rays, related messages, and the amount of ultraviolet rays accumulated, step 302 is repeated until the detector 100 or 200 is turned off.

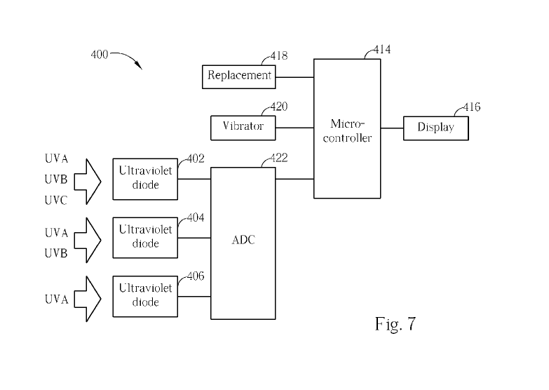

Please refer to FIG. 7. FIG. 7 is a functional diagram showing the detector of the third embodiment of the present invention. Similar to the detector 100, detector 400 detects the intensity of the ultraviolet rays according to the light voltage generated after the ultraviolet photo-diode is irradiated by the ultraviolet rays. The detector 400 also includes an A/D converter 422, a display 416, a replacement button 418, and a vibrator 420. These devices function in a similar fashion as the A/D converter 112, the display 106, the replacement button 108, and the vibrator 110 of the detector 100. In contrast to the detector 100, the detector 400 includes a plurality of ultraviolet photo-diodes 402, 404, and 406 for detecting ultraviolet rays of different wave bands and the micro-controller 414 of the detector 400 also calculates the intensity of ultraviolet rays differently compared to the micro-controller 104. Despite the fact that the ultraviolet photo-diodes 402, 404, and 406 will produce corresponding light voltage from the ultraviolet irradiation, the detectable wave bands of each diode however are likely to vary due to different composition of the diodes.

According to the third embodiment of the present invention, the detectable wave bands for the ultraviolet photo-diode 402 are represented by UVA, UVB, and UVC, in which the detectable wave bands for the ultraviolet photo-diode 404 are UVA and UVB, and the detectable wave band for the ultraviolet photo-diode 406 only is UVA. Hence the detectable overlapping wave band for the ultraviolet photo-diodes 402-406 is UVA and the detectable overlapping wave bands for the ultraviolet photo-diodes 402 and 404 are UVA and UVB. In order to obtain the intensity of ultraviolet rays in each wave band UVA, UVB, and UVC, the micro-controller 414 first calculates the ultraviolet intensity in UVA according to the light voltage signal output from the ultraviolet photo-diode 406, then calculates the total ultraviolet intensity in UVA and UVB according to the light voltage signal output from the ultraviolet photo-diode 404, and finally subtracts the ultraviolet intensity in UVA from the total ultraviolet intensity in UVA and UVB to obtain the ultraviolet intensity in UVB. In the same fashion, the ultraviolet intensity in UVC can also be obtained according to the output signal generated by the two ultraviolet photo-diodes 402 and 404. In contrast to the detector 10, the detector 400 not only lacks a placement of a filter, but also includes the ultraviolet photo-diodes 402-406 that are comprised of different materials. As a result, several detectable overlapping wave bands will be observed, and according to the output signal, the ultraviolet intensity in each overlapping wave band can be calculated.

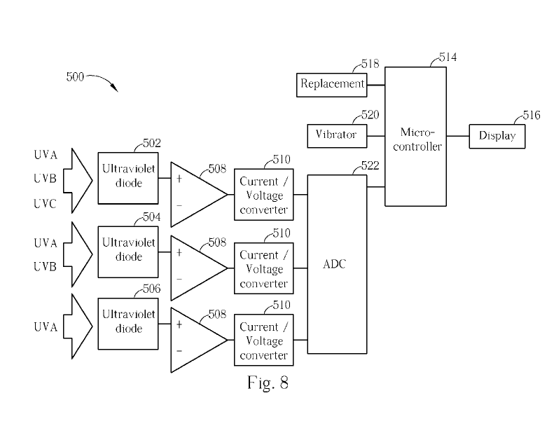

Please refer to FIG. 8. FIG. 8 is a functional diagram showing the detector of the fourth embodiment of the present invention. Similar to the detector 400, the detector 500 also includes an A/D converter 522, a display 516, a replacement button 518, and a vibrator 520. These devices function in a similar fashion as the A/D converter 412, the display 406, the replacement button 408, and the vibrator 410 of the detector 400. In contrast to the detector 400, the detector 500 essentially determines the ultraviolet intensity in each wave band according to the light current generated by the plurality of ultraviolet photo-diodes 502, 504, 506 from the irradiation of ultraviolet rays. Despite the fact that the ultraviolet photo-diodes 402, 404, and 406 will produce corresponding light voltage from the ultraviolet irradiation, the detectable wave bands of each diode however are likely to vary due to different composition of the diodes. According to the fourth embodiment of the present invention, the detectable wave bands for the ultraviolet photo-diode 502 are represented by UVA, UVB, and UVC, in which the detectable wave bands for the ultraviolet photo-diode 504 are UVA and UVB, and the detectable wave band for the ultraviolet photo-diode 506 only is UVA. Hence the detectable overlapping wave band for the ultraviolet photo-diodes 502-506 is UVA and the detectable overlapping wave bands for the ultraviolet photo-diodes 502 and 504 are UVA and UVB. After magnified by the amplifier 508, the electrical current signals output from the ultraviolet photo-diodes 502-506 will be transmitted to the current/voltage converter 510. After the current signals are converted to voltage signals, the A/D converter 522 will convert the magnified electric current signals to corresponding digital signals and pass the converted signals to the micro-controller 514. Similar to the micro-controller 414 from FIG. 7, the micro-controller 514 of the detector 500 calculates the ultraviolet intensity of each overlapping wave band according to the overlapping condition of the wave bands of the ultraviolet photo-diodes 502-506.

In contrast to the detector 100 and 200 that utilizes a fixed ratio for calculating the ultraviolet intensity in different wave bands, the detector 400 utilizes the signals output from the ultraviolet photo-diodes 402-406 for calculating the ultraviolet intensity in different wave bands. Hence the usage of the detector 400 is not restricted to a stable light source (such as daylight), but to a much wider range of applications.

In contrast to the ultraviolet detector from the prior art, the present invention provides a simple and practical ultraviolet detector that is capable of detecting the intensity of ultraviolet rays in various wave bands by utilizing a single ultraviolet photo-diode. In addition, the method for detecting the ultraviolet intensity disclosed by the present invention is also applicable for calculating the ultraviolet intensity in each overlapping wave band by utilizing the ultraviolet photo-diodes comprised with different materials.

Those skilled in the art will readily observe that numerous modifications and alterations of the device and method may be made while retaining the teachings of the invention. Accordingly, the above disclosure should be construed as limited only by the metes and bounds of the appended claims.

1. A method for detecting intensity of ultraviolet rays in a plurality of wave bands comprising:
utilizing an ultraviolet photo-diode for detecting the ultraviolet rays within a predetermined time;
collecting an input signal from the ultraviolet photo-diode after the ultraviolet photo-diode is irradiated by the ultraviolet rays within the predetermined time for calculating a total intensity of the ultraviolet rays; and
multiplying the total intensity of the ultraviolet rays by a corresponding ratio of each wave band for calculating the intensity of ultraviolet rays in each wave band.

2. The method of claim 1 further comprising:
grounding the ultraviolet photo-diode after the predetermined time is ended.

3. A method for detecting the intensity of ultraviolet rays in a plurality of wave bands comprising:
utilizing a plurality of ultraviolet photo-diodes for detecting a plurality of ultraviolet wave bands within a predetermined time, in which each of the detected wave bands overlaps with at least one of the other detected wave bands;
collecting input signals from the ultraviolet photo-diodes after the ultraviolet photo-diodes are irradiated by the ultraviolet rays within the predetermined time for calculating a total intensity of the ultraviolet rays in each detected wave band; and
calculating the ultraviolet intensity in each overlapping wave band of the detected wave bands according to the total intensity of the ultraviolet rays in the detected wave bands and the overlapping condition of each wave band.

4. The method of claim 3 further comprising:
grounding the ultraviolet photo-diode after the predetermined time is ended.

5. A detector for detecting the intensity of ultraviolet rays comprising:
a plurality of ultraviolet photo-diodes for detecting a plurality of ultraviolet wave bands and generating corresponding analog signals, in which each of the detected wave bands overlaps with at least one of the other detected wave band;
an analog/digital converter electrically connected to the ultraviolet photo-diode for converting analog output signals of the ultraviolet photo-diodes into corresponding digital signals; and
a micro-controller electrically connected to the analog/digital converter for controlling the detector and calculating the intensity of ultraviolet rays within each overlapping wave band according to the digital signals converted by the analog/digital converter.

6. The detector of claim 5 further comprising a display that electrically connects to the micro-controller for showing the intensity of ultraviolet rays within each overlapping wave band generated by the micro-controller.

7. The detector of claim 5 further comprising a vibrator that electrically connects to the micro-controller for generating a time signal, the micro-controller being operated according to the time signal.
